(19) United States
(12) Patent Application Publication
(10) Pub. No.: US 2012/0173422 A1
(43) Pub. Date: Jul. 5, 2012

(54) INSTANT BANK FUND TRANSFERS

(75) Inventor: Qilin Hu, Cupertino, CA (US)

(73) Assignee: EBAY INC., San Jose, CA (US)

(21) Appl. No.: 12/982,816

(22) Filed: Dec. 30, 2010

(51) Int. Cl. G06Q 40/00

(52) U.S. Cl. 705/44; 705/39

(57) ABSTRACT

Embodiments for instant banking funds transfers include methods and systems for providing financial services. The financial services provided include instant top up of an account with a Financial Service Provider (FSP), instant account verification (using instant deposit confirmation); instant direct debit; and instant withdrawal or funds out. In one or more embodiments, an FSP has an agreement and a cash account with a partner bank; other banks, where users of the financial services have accounts, also have cash accounts with the partner bank. Thus, any transfers can be made within the partner bank and instantaneously. The FSP receives cash during a normal three to five day settlement period with standard bank transfers. Financial services provided may include instant top up of funds (instant credit), instant bank confirmation (using random deposits), instant debit, and instant withdrawal (or funds out).

### BACKGROUND

1. Technical Field

Embodiments of the present invention generally relate to methods and systems for facilitating financial transactions and, more particularly, to instant credit transfers, bank account confirmations, and bank fund transfers.

2. Related Art

The International Standards Organization (ISO) is a worldwide federation of national standards bodies. The ISO International Standard ISO 20022, “Universal Financial Industry Message Scheme”, is intended to provide the financial industry with a common platform for the development of messages in a standardized XML (Extensible Markup Language) syntax, using: 1) a modeling methodology (based on UML—Unified Modeling Language) to capture in a syntax-independent way financial business areas, business transactions and associated message flows; and 2) a set of XML design rules to convert the messages described in UML into XML schemas. This flexible framework allows communities of users and message development organizations to define message sets according to an internationally agreed approach and to migrate to the use of common XML-based syntax.

Society for Worldwide Interbank Financial Telecommunication (SWIFT) provides a global banking network (SWIFTNet) system for funds transfers between banks that is generally economical for individual users but requires a few business days, typically three, for the settlement of transactions, e.g., fund transfers, in which the recipient of funds may experience delay in the funds becoming available for use.

Real-time gross settlement systems (RTGS) are funds transfer systems where money is moved from one bank to another in “real-time” and on “gross” basis. Settlement in “real time” means the payment transaction is not subjected to any waiting period; the transactions are settled as soon as they are processed. Settlement on “gross” basis means each transaction is settled on a one-to-one basis without netting or grouping with any other transactions. In general, RTGS, typically used by companies, organizations, and institutions, is the fastest possible way to transfer money. Once processed, payments are final and irrevocable, but also requires a significant fee from the user. RTGS systems may vary from country to country and is usually maintained and controlled by the Central Bank of a country. For example, Clearing House Automated Payments System (CHAPS) is used in the United Kingdom, while Fedwire is used in the United States. Compared, for example, to SWIFTNet, the RTGS system is suited for low-volume, high-value transactions, and thus may be prohibitively expensive for individual users.

### SUMMARY

According to one or more embodiments of the present invention, methods and systems for providing instant financial services include instant top up of an account with a Financial Service Provider (FSP), instant account verification (using instant deposit confirmation), instant direct debit, and instant withdrawal or funds out. In one or more embodiments, an FSP has an agreement and a cash account with a partner bank; other banks, where users of the financial services have accounts, also have cash accounts with the partner bank. Thus, any transfers can be made within the partner bank and instantaneously. The FSP receives cash during a normal three to five day settlement period with standard bank transfers. Financial services provided may include instant top up of funds (instant credit), instant bank confirmation (using random deposits), instant debit, and instant withdrawal (or funds out).

In one or more embodiments, a system includes: a first cash account managed by a computer at a partner bank of a financial service provider (FSP) and owned by the FSP; a second cash account managed by a computer at the partner bank of the FSP and owned by a financial institution where a user has an account; and an application programming interface (API) for communication of financial transactions between the partner bank of the FSP and the financial institution where the user has an account so that a financial service is provided instantly to the user via the API and use of internal funds transfers between the first cash account and the second cash account at the partner bank.

In another embodiment, a method includes: maintaining a first cash account, owned by a financial service provider (FSP), at a partner bank; maintaining a second cash account, owned by a financial institution where a user has an account, at the partner bank; invoking an application programming interface (API) for communication of financial transactions between the partner bank of the FSP and the financial institution where the user has an account; and providing an instant financial service to the user via the API and use of internal funds transfers between the first cash account and the second cash account at the partner bank.

In a further embodiment, a computer program product comprises a computer readable medium having computer readable and executable code for instructing a processor to perform a method that includes: maintaining a first cash account, owned by a financial service provider (FSP), at a partner bank; maintaining a second cash account, owned by a financial institution where a user has an account, at the partner bank; invoking an application programming interface (API) for communication of financial transactions between the partner bank of the FSP and the financial institution where the user has an account; and providing an instant financial service to the user via the API and use of internal funds transfers between the first cash account and the second cash account at the partner bank.

### BRIEF DESCRIPTION OF THE DRAWINGS

FIG. 1 is a system diagram illustrating a system for financial transactions in accordance with an embodiment of the present invention.

FIG. 2 is a system diagram illustrating a transaction in a system for financial transactions in accordance with an embodiment.

FIG. 3 is a system diagram illustrating operation of a system for financial transactions in accordance with an embodiment.

FIG. 4 is a flow chart illustrating a method for instant top-up in a system for financial transactions in accordance with an embodiment.

FIG. 5 is a flow chart illustrating a method for instant account verification in a system for financial transactions in accordance with an embodiment.

FIG. 6 is a flow chart illustrating a method for instant direct debit in a system for financial transactions in accordance with an embodiment.

FIG. 7 is a flow chart illustrating a method for instant withdrawal (or funds out) in a system for financial transactions in accordance with an embodiment.

### DETAILED DESCRIPTION

Embodiments of the present invention relate to providing a global network for instant transfer of funds between financial institutions (for brevity “bank” has been used for the more general term “financial institution” in the illustrative examples that follow, but no limitation of financial institutions only to banks is intended unless specifically stated) that enables several services to be provided by a financial service provider (FSP) to a user, who may perceive the services as being provided by the service provider or other financial institutions such as banks. The services may include, for example, instant top-up, instant account confirmation, instant direct debit, and instant funds out (or withdrawal). The services may be built on or may exploit the use of immediate, or “real-time”, funds transfers provided by the global network for instant transfer of funds that may be enabled by the FSP. “Instant” means the payment transaction is not subjected to any waiting period; the transactions are settled as soon as they are processed, comparable to real-time settlement systems such as RTGS. Transfers may take place, for example, between banks regardless of whether the banks are in the same country or different countries. Transactions conducted using the instant global funds transfer network according to one or more embodiments may be more economical for use by individuals than RTGS systems yet provide faster settlement than transactions that clear through SWIFTNet.

For example, the RTGS system is suited for low-volume (e.g., less than a hundred per day per institution), high-value (e.g., more than $10,000) transactions. RTGS systems are an alternative to systems of settling transactions at the end of the day, also known as net settlement systems, for example, Automated Clearing House (ACH) or SWIFTNet. In a net settlement system, all the inter-institution transactions during the day are accumulated. At the end of the day, the accounts of the institutions are adjusted.

A system according to one or more embodiments may be more convenient for users than a typical net settlement system. For example, transactions may be conducted on-line rather than the user having to walk up to a bank counter or teller window; the funds recipient may receive funds right away so that the user's transaction may be completed more quickly; and errors may be detected and corrected right away instead of taking perhaps as long as a week to correct, as in some conventional systems, during which time neither the user nor the recipient may have use of the money. For banks or financial institutions, the faster service provided by an embodiment may allow the bank to charge more for the faster service than for a conventional net settlement system funds transfer. Also, suitability for low-value funds transfers using an embodiment may lead to wider usage than that of RTGS, increasing volume of business for the bank providing the faster service.

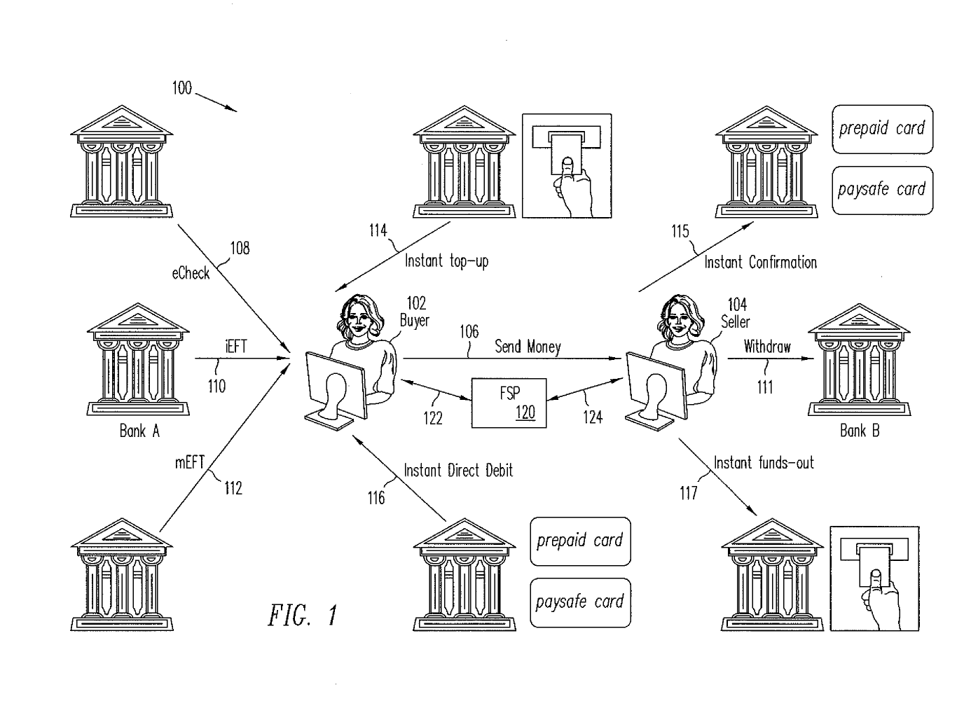

FIG. 1 illustrates a system 100, according to one embodiment, for facilitating financial transactions, e.g., transactions involving money in any of its various forms supported by system 100, in which a buyer 102 and seller 104 may wish to conduct a transaction 106, which may include sending money from buyer 102 to seller 104. Buyer 102 may be able to use any of several different mechanisms for sending money from an account at a bank (or other financial institution or financial service provider), for example, of the buyer 102 to seller 104 for accomplishing transaction 106. For example, buyer 102 may use an eCheck 108, an integrated electronic fund transfer (iEFT) 110, or a manual electronic funds transfer (mEFT) 112 to fund the transaction 106. Note that buyer and seller are used as an example, as any payer and payee may use features herein to effect instant money or fund transfers.

Using eCheck 108, buyer 102 may perform a credit/debit transaction that is similar to the use of a regular bank check, which is generally familiar to most people Like a regular bank check, an eCheck 108 may be settled using the Automated Clearing House (ACH) network and may generally take 3 to 5 business days to clear, e.g., to be settled, meaning that the bank account of the recipient, also referred to as “creditor”, e.g., seller 104, has been credited (recipient has full use of the money) and the bank account of the payer, also referred to as “debtor”, e.g., buyer 102, has been debited (payer no longer has use of the money). With eCheck 108 the money may be paid to seller 104 from an account of buyer 102 by direct debit, which is a method of ACH collection in which the debtor, e.g., buyer 102, gives authorization to debit the account of buyer 102 upon the receipt of an entry issued by the creditor, e.g., seller 104.

A financial service provider (FSP) 120, such as PayPal, Inc. of San Jose, Calif., may provide a service (e.g., acting as an intermediary between buyer 102 and seller 104) that insulates buyer 102 from seller 104 by allowing completion of transaction 106 through the FSP 120 via transaction 122, between buyer 102 and FSP 120, and transaction 124, between seller 104 and FSP 120, as shown in FIG. 1. For example, FSP 120 may provide an eCheck 108 transaction in which buyer 102 sends money to FSP 120, and FSP 120 may then send the money to seller 104 using a transaction 124 between FSP 120 and seller 104 that is agreeable to both parties. In this way, information need only pass between seller 104 and FSP 120 without seller 104 needing to know any financial information about buyer 102. Using this eCheck service, buyer 102 may give authorization to debit the account of buyer 102 upon the receipt of an entry issued by the FSP 120. The authorization may be enabled, for example, by buyer 102 providing the FSP 120 with appropriate information about the bank and account of buyer 102.

Because an eCheck may take 3 to 5 business days to clear, the transactions 122 and 124 may show, respectively, to both buyer 102 and seller 104, as pending until the transactions clear so that seller 104 may not wish to ship goods until a few days after buyer 102 has made the purchase, thus giving the buyer 102 a sense or feeling of delay with an eCheck type of transaction.

Returning to FIG. 1, using iEFT 110, buyer 102 may perform an integrated electronic fund transfer through the FSP 120. To use the iEFT service provided by FSP 120, buyer 102 may or may not provide the FSP 120 with appropriate information about the bank and account of buyer 102. Using this iEFT service, the buyer 102 may initiate the transaction 106 on a website of FSP 120 and the buyer 102 may be redirected to an on-line banking web page of the bank of buyer 102, Bank A. Buyer 102 may log on to Bank A at the on-line banking web page, and Bank A may provide buyer 102 the capability to confirm the payment and the amount. Once the buyer 102 confirms the payment and amount, the FSP 120 may receive instant payment verification, e.g., the payment is approved, authorization is completed, and it may be guaranteed to FSP 120 to receive payment within, for example, 2 to 3 days. At that time, because the money is deemed safe, FSP 120 may make immediate payment to the seller 104, e.g., release the funds or credit the funds to the seller 104. Seller 104 may then promptly ship the goods, thus giving the buyer 102 a sense or feeling of instant response with an iEFT type of transaction in contrast to the sense of delay with an eCheck type of transaction.

Referring again to FIG. 1, using mEFT 112, buyer 102 may perform a manual electronic funds transfer through the FSP 120. To use the mEFT service provided by FSP 120, buyer 102 may or may not provide the FSP 120 with appropriate information about the bank and account of buyer 102. Using this mEFT service, the buyer 102 may provide FSP 120 with funds to be kept with FSP 120 in a user account of buyer 102. In effect, funds for the transaction 106 will be prepaid into an account with FSP 120 by the buyer 102. The funds may be prepaid, for example, prior to buyer 102 initiating the transaction 106 by providing some arbitrary amount of funds, enough to cover the amount of transaction 106, into the FSP user account of buyer 102. The funds also, for example, may be prepaid concurrently with and before completion of processing of transaction 106. In addition, if the FSP is willing to extend credit, for example, to the buyer 102, the funds may also be “prepaid” after transaction 106 is completed. Having prepaid, in one form or another, appropriate funds to FSP 120 (e.g., via transaction 122), buyer 102 may initiate the transaction 106 on a website of FSP 120. FSP 120 may then send the money to seller 104 using an appropriate method for accomplishing transaction 124. In this way, information need only pass between seller 104 and FSP 120 without seller 104 needing to know any financial information about buyer 102. With mEFT, as with iEFT, because the money is deemed safe, FSP 120 may make immediate payment to the seller 104, e.g., release the funds or credit the funds to the seller 104, and seller 104 may then promptly ship the goods, thus giving the buyer 102 a sense or feeling of instant response with an mEFT type of transaction in contrast to the sense of delay with an eCheck type of transaction.

Also with the mEFT, buyer 102 may have a sense or feeling of enhanced privacy or security in that neither a credit card nor bank checking type of transaction need occur between buyer 102 and FSP 120 for each transaction, but only on occasions when the buyer 102 realizes a need to replenish the FSP user account of buyer 102. For example, buyer 102 may replenish the FSP user account of buyer 102 using the bill pay payment system commonly available in U.S. banks. To use the bill pay system, buyer 102 may, for example, log on to the website of Bank A (the bank of buyer 102) and specify FSP 120 as a payee for a specified amount using Bank A's bill pay service. The specified amount may then be credited to the FSP user account of buyer 102 (also referred to as “top-up” of funds) to be ready for use by buyer 102 in conjunction with the mEFT service of FSP 120.

Returning again to FIG. 1, seller 104 may have several options for receiving the money sent by buyer 102 in transaction 106 from FSP 120 and putting the money into a bank account of seller 104. In one option, the seller 104 may maintain a seller account with FSP 120. Once the FSP 120 has provided the money from transaction 106 to the FSP seller account of seller 104, seller 104 may then withdraw the money (withdrawal 118) from the FSP seller account and, for example, deposit it with the bank of seller 104, Bank B.

FSP 120 may provide financial services that allow instant fund transfers, e.g., fund transfers in real time—such as those accomplished by RTGS systems—but adapted to low value transfers—such as those accomplished by SWIFTNet or ACH transfers. The instant fund transfers may, however, be provided more economically than by RTGS and more quickly than by SWIFTNet. Some of the financial services are illustrated in FIG. 1 as an instant top-up 114, an instant account verification (using withdrawals and confirmation) 115, an instant direct debit 116, and an instant funds out (or withdrawal) 117.

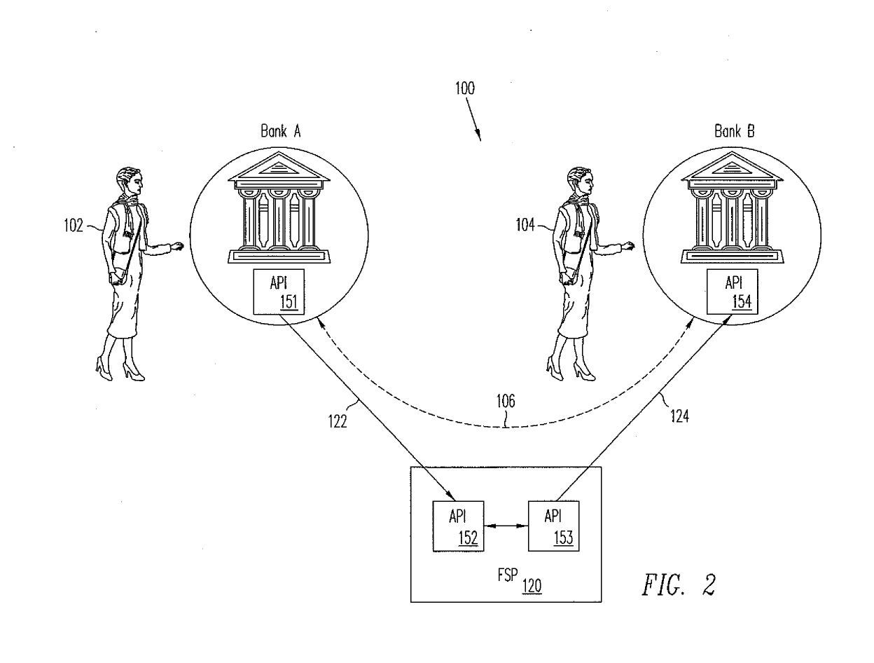

FIG. 2 illustrates a portion of system 100 for facilitating financial transactions according to one embodiment. Financial service provider 120 may provide system 100 as a bank-to-bank fund transfer network to which Bank A and Bank B belong, enabling instant or real-time transfer of transaction 106 between Bank A and Bank B. The network of system 100 may be global, and Bank A and Bank B may be in the same or different countries. Transaction 106 may occur from a user (e.g. buyer 102 or ultimate debtor) of Bank A and a user (e.g., seller 104 or ultimate creditor) of Bank B, and in the case that user 104 is identical to user 102 it may be understood that user 102 is thus able to transfer money between his or her own accounts at different banks using system 100.

Bank A may offer interbank, instant funds transfers for banks in the network of system 100 as a product through on-line banking. A user (e.g., buyer 102 or ultimate debtor) having an account at Bank A may, for example, log on to an on-line banking web page of Bank A, and choose the global instant funds transfer service. The buyer 102 may then be presented, for example, with a drop down list of banks in the network of system 100 to which a transfer can be made. Upon the buyer 102 providing enough information (e.g., transfer amount, destination bank, destination account number, or seller 104 identification), Bank A may invoke an application programming interface (API) 151 to accomplish the transfer transaction 106. API 151, as well as APIs 152, 153, and 154, may be pre-defined such as ISO 20022 “FIToFICreditTransfer”. API 151 may communicate with API 152 for performing transaction 122. Based on the information received by API 152 from Bank A, API 152 may chain to API 153 to communicate with API 154 at Bank B to perform transaction 124 so that transaction 106 between user 102 and user 104 may be completed. By chaining APIs in this manner, FSP 120 may form the network of system 100 and enable instant global interbank funds transfer via the network of system 100.

As seen in FIG. 2, transfer transaction 106 may be completed in several steps or links through FSP 120, which may be transparent to user 102 and user 104 as indicated by the dashed line representing transaction 106 in FIG. 2. In other words, user 102 may perceive that user 102 only needs to deal with Bank A in order to accomplish the entire transaction 106, without user 102 being aware of FSP 102 or partial transactions 122 and 124. On the other hand, Bank A may display, for example, on its on-line banking webpage that enables use of the funds transfer service, a trademark or logo of FSP 120 to indicate affiliation of the network of system 100 or the funds transfer service provided by Bank A with FSP 120. Such information may be displayed by Bank A for purposes of using the good will associated with the name of FSP 120 in encouraging trust of user 102 in system 100 and the funds transfer service provided by Bank A.

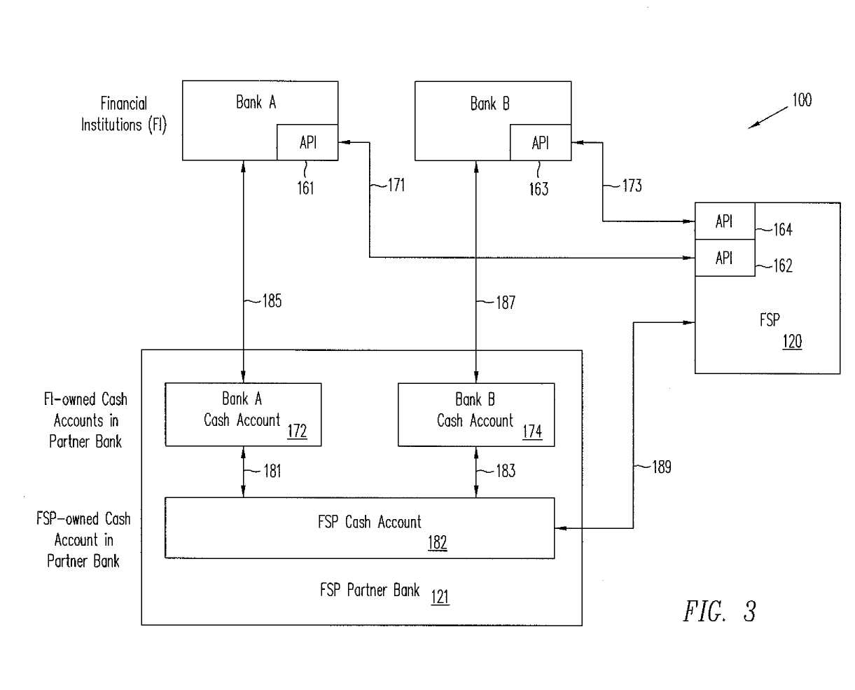

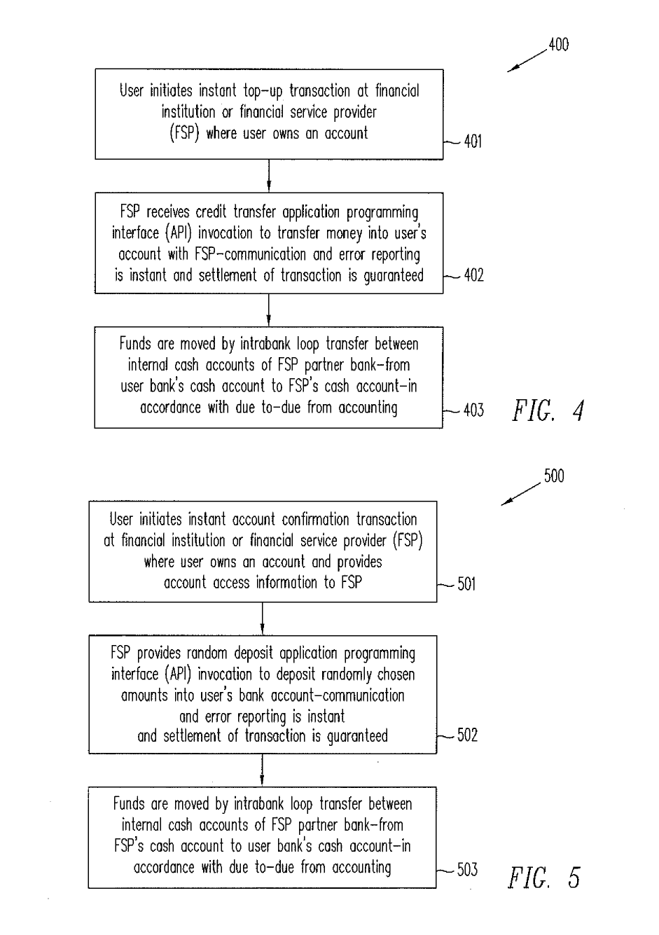

FIG. 3 illustrates an example of various operations of system 100 for financial transactions. In system 100, according to one or more embodiments, instant bank funds transfers can be made, on behalf of various users, between financial institutions, which in the example of FIG. 3 are illustrated by banks Bank A, Bank B, and a partner bank 121 of FSP 120. Users may be different users of the same or different banks, for example, or the same user may wish to transfer funds between that user's own accounts at different banks. As shown in FIG. 3, Bank A may be a bilateral bank, meaning there is an established bilateral relationship between Bank A and FSP partner bank 121. FSP partner bank 121 may provide a hosting service for cash accounts, e.g., business checking accounts, some of which are owned by banks in the system 100, e.g., Bank A cash account 172 owned by Bank A, and some of which are owned by FSP 120, e.g., FSP cash account 182.

For example, if a user of Bank A wishes to transfer money to the user's account with FSP 120 (also referred to as “instant top up”), the Bank A user may so instruct Bank A and Bank A may begin a transaction 171 for transfer of funds using API 161 and API 162 to move funds (e.g., transfer 185) from the user's account at Bank A to Bank A's cash account 172 at FSP partner bank 121. FSP partner bank 121 may then make an internal transfer 181 of funds between Bank A's cash account 172 and FSP cash account 182. FSP partner bank 121 may use cash accounts 172, 174, and 182, by which multiple transactions—such as transfers 181 and 185—are netted to maintain an aggregate balance for each cash account. The financial institutions in system 100, e.g., Bank A and FSP partner bank 121, may use a due to-due from accounting model for operating the network of system 100. Due to-due from accounts (as opposed, e.g., to transfer accounts) generally are similar to liability accounts in that they appear on the Balance Sheet of year-end statements and maintain a balance at the end of the year that is carried forward to the next year. This type of account is usually used for transferring money between companies. By way of contrast, transfer accounts generally are similar to expense accounts in that their balance is closed into the fund balance account at the end of the year and they appear on the Income Statement. This type of account is usually used for balancing transactions across funds.

As another example, if a user of FSP 120 wishes to transfer money from the user's account with FSP 120 to the account of a user (which may be the same or a different user) of Bank B (also referred to as “instant withdrawal”), the FSP user may so instruct FSP 120 and FSP 120 may begin a transaction 173 for transfer of funds using API 164 and API 163 to move funds (e.g., transfer 187) from the user's account at FSP 120 to Bank B's cash account 174 at FSP partner bank 121. FSP partner bank 121 may then make an internal transfer 183 of funds between FSP cash account 182 and Bank B's cash account 174. FSP partner bank 121 may use cash accounts 172, 174, and 182, by which multiple transactions—such as transfers 183 and 187—are netted to maintain an aggregate balance for each cash account.

Transfers, such as those illustrated by the preceding two examples, from a user of Bank A to an account at FSP 120 and from an FSP user to an account at Bank B may be completed instantly because: 1) transfer 181 and transfer 183 are internal funds transfers of FSP partner bank 121, 2) transfer 185, occurring between Bank A and its own cash account 172 with FSP partner bank 121, may be accomplished by properly crediting and debiting the appropriate accounts via the use of API 161, API 162, and transaction 171, and 3) transfer 187 may be accomplished, like transfer 185, by properly crediting and debiting the appropriate accounts via the use of API 164, API 163, and transaction 173, without actual movement of funds between the entities and their own cash accounts (e.g., cash accounts 172, 174, 182) at FSP partner bank 121.

To facilitate immediate settlement of transactions (e.g., transaction 106 shown in FIGS. 1 and 2), each financial institution (e.g., Bank A and Bank B) and the FSP 120 may take steps to ensure that each cash account in the FSP partner bank 121 maintains a large enough balance for settlement of a few days of transactions on a total aggregate basis. For example, FSP 120 may make funds transfers 189, and Bank A and Bank B may make funds transfers 185 and 187 respectively. Thus, at the end of each day, FSP 120 may issue fund transfer instructions to FSP partner bank 121; for example: “Today there is net $1,000,000.00 transaction payment amount from Bank A cash account to FSP cash account hosted by FSP partner bank.” Because both cash accounts are hosted by the same bank, e.g., FSP partner bank 121, the instruction is satisfied by an intrabank account loop transfer. An intrabank loop transfer is instant. For example, error reporting can take place immediately, e.g., if any cash account has an insufficient balance. Thus, transactions, such as funds transfer transaction 106, may be settled immediately, e.g., do not take a number of business days to clear as with a conventional transfer made using, for example, SWIFTNet or ACH. System 100 may be scalable in the sense that a new bank (or financial institution) may integrated into the system in practicably short amount of time so that the system can grow by hundreds to thousands of new financial institutions within a moderate time horizon, for example, 100 new banks within a year rather than 1 year for each new bank.

For example, integrating Bank B into system 100 may require setting up Bank B's cash account 174 to be hosted by FSP partner bank 121 for facilitating intrabank loop transfers 183. Open APIs, that is, APIs defined by ISO rather than the FSP 120—such as ISO 20022 APIs “FIToFICreditTransfer”—may be used so that not only the FSP 120 can implement and host appropriate APIs, but the new financial institution, e.g., Bank B for this example, can also invoke and host the appropriate APIs; thus, API invocation is bi-directional. With such an approach, integration of a new bank, e.g., Bank B, may require only configuring pre-defined APIs, e.g., configuring API 163 and API 164 for performance of transactions 173. Configuring the open APIs can save significant amount of product development time (e.g. up to about one year in each case) that would otherwise conventionally be required on the part of FSP 120 on a customized basis for each new financial institution.

FIG. 4 illustrates a method 400 for transferring funds instantly in a global financial network such as system 100 according to one embodiment. At step 401, a user (e.g., buyer 102) may log in to the user's account at a financial institution (e.g., Bank A) using, for example, on-line banking provided by Bank A. The user may choose a transaction to perform, and may provide additional choices and information as described above with reference to FIG. 2. For this example, the transaction is instant top-up of the user's account with the FSP 120, e.g., the user wishes to move funds from his account with Bank A to his account with FSP 120. At the end of the day, if that transaction is the only one for Bank A, that may be the only fund transfer issued to FSP partner bank 121 in that case; otherwise, several transactions may be netted against each other and an aggregate fund transfer issued to FSP partner bank 121 at the end of the day.

On day 1, in real-time, at step 402, FSP 120 may receive the credit transfer API invocation from Bank A to top up $100 (in this example, to illustrate that some specific amount of funds is chosen by the user, $100 is used as the chosen amount) of its FSP user's (e.g., buyer 102) account balance. Because the API provides instant results, the money movement settlement is guaranteed, FSP 120 reliance on availability of funds is safe.

Upon receipt of the instructions via the API, at step 403, FSP 120 may use an internal cash account (e.g., a general ledger account) which is hosted inside the instant global funds transfer network of system 100 (e.g., hosted by FSP partner bank 121) to credit the $100 to the user's account with FSP 120 immediately (because money movement settlement is guaranteed) and then waits the standard 3 to 5 days for settlement. Because FSP 120 can credit the funds immediately (e.g., via transaction 181 using, for example, intrabank loop transfers) to the user's account with FSP 120, FSP 120 may release the funds immediately for completion of a transaction desired by the user of Bank A (e.g., buyer 102). For example, FSP 120 may release funds immediately to a seller 104, who then may process buyer's 102 order and proceed immediately to ship goods.

FIG. 5 illustrates a method 500 for instant account verification in a global financial network such as system 100 according to another embodiment. At step 501, a user (e.g., buyer 102) may log in to the user's account at a financial service provider (e.g., FSP 120). For this example, the user may wish to set up access of the user's account at the user's bank (e.g., Bank A) so that, for example, the user can withdraw funds from the user's account with FSP 120 and transfer those funds directly to the user's account at Bank A. Access to the user's account at Bank A may allow FSP 120 to make such transfers by, for example, depositing money into the user's account at Bank A. In order to confirm the information (e.g., user's account number) provided by the user, FSP 120 may make, for example, two small (e.g., less than one dollar) deposits of random amounts to the user's account at Bank A using the information. The information may be confirmed when the user accesses the user's account at Bank A, learns the deposit amounts, and confirms the deposit amounts by communication with the FSP. As with instant top up, the deposit transactions may be netted with several others and an aggregate fund transfer issued to FSP partner bank 121 at the end of the day.

On day 1, in real-time, at step 502, FSP 120 may provide a deposit API invocation to Bank A to deposit the random amounts to its FSP user's (e.g., buyer 102) account balance. Because the API provides instant results, the money movement settlement is guaranteed, FSP 120 reliance on availability of funds is safe. Thus, FSP 120 may rely on the random deposit amounts to be confirmed by the user of Bank A to match what it knows the amounts to be.

Upon receipt of the instructions via the API, at step 503, FSP partner bank 121 may use an internal cash account (e.g., a general ledger account) which is hosted inside the instant global funds transfer network of system 100 (e.g., hosted by FSP partner bank 121) to credit the random deposit amounts (e.g., via transfers 181) to the user's Bank A cash account 172 with FSP partner bank 121 immediately (because money movement settlement is guaranteed) and then waits the standard 3 to 5 days for settlement. Because FSP 120 can credit the funds immediately to the user's account with FSP 120, FSP 120 may release the funds immediately for the user of Bank A (e.g., buyer 102) who can then confirm the amounts immediately with the FSP 120 for instant bank account verification.

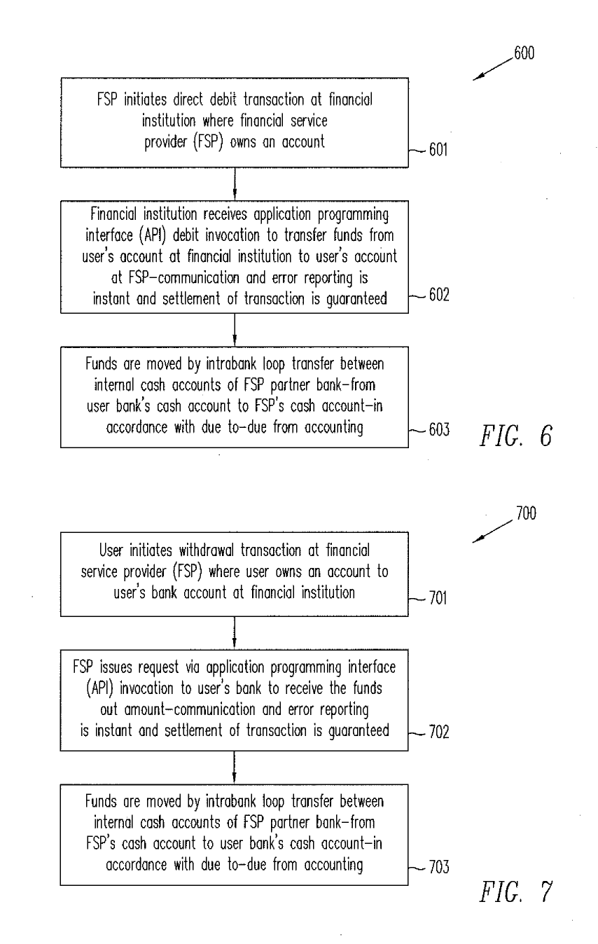

FIG. 6 illustrates a method 600 for instant direct debit in a global financial network such as system 100 according to another embodiment. At step 601, a user (e.g., buyer 102) may log in to the user's account at a financial service provider (e.g., FSP 120) or at the user's bank (e.g., Bank A). For this example, the user may wish to set up direct debit of the user's account at the user's bank (e.g., Bank A) so that, for example, a payee (e.g., seller 104) can withdraw (e.g., be paid directly with) funds from the user's account at Bank A. So for example, funds may be transferred from user's account at Bank A to the payee's account at, for example, Bank B. Upon the user's instructions, the FSP 120 may initiate a direct debit transaction at financial institution where the FSP 120 owns an account, e.g., FSP partner bank 121. As with instant top up, the direct debit transactions may be netted with several others and an aggregate fund transfer issued to FSP partner bank 121 at the end of the day.

On day 1, in real-time, at step 602, the financial institution where the user owns an account (e.g., Bank A) may receive a debit API invocation to transfer funds from the user's account at the financial institution to the user's account at FSP 120. So, Bank A may allow transfer of $100 (in this example, to illustrate that some specific amount of funds is chosen by the user, $100 is used as the chosen amount) of the user's (e.g., buyer 102) account balance to an account at FSP partner bank 121. Because the API provides instant results, the money movement settlement is guaranteed, e.g., reliance by FSP partner bank 121 on availability of funds in Bank A cash account 172 is safe.

Upon receipt of the instructions via the API, at step 603, FSP partner bank 121 may use internal cash accounts (e.g., a general ledger account) which are hosted inside the instant global funds transfer network of system 100 (e.g., hosted by FSP partner bank 121) to credit the $100 to the cash account 182 of FSP 120 via transaction 181 using, for example, intrabank loop transfers. Thus, money may be credited to the user's FSP account at FSP partner bank 121 immediately (because money movement settlement is guaranteed) even though FSP 120 may wait the standard 3 to 5 days for settlement. Because FSP 120 can credit the funds immediately to the user's account with FSP 120, FSP 120 may release the funds immediately for completion of a transaction desired by the user of Bank A (e.g., buyer 102). For example, FSP 120 may release funds immediately to seller 104, who then may process the order of buyer 102 and proceed immediately, for example, to ship goods to buyer 102.

FIG. 7 illustrates a method 700 for instant withdrawal in a global financial network such as system 100 according to another embodiment. In this example, illustrative of money transfer reverse in direction to the top-up example, the user of FSP 120 (e.g., buyer 102) may wish to withdraw funds (or take funds out) from the user's account with FSP 120 to put the funds into the user's account with, for example, Bank A. The user would like for the funds to show up instantly on the on-line banking web page of Bank A. At step 701, the user may log in to the user's account at Bank A using, for example, on-line banking provided by Bank A. Alternatively, at step 701, the user may log in to the user's account at FSP 120 using, for example, on-line services provided by FSP 120. The user may choose the transaction to perform and provide additional choices and information. As with the preceding examples, the transaction may be netted with several others and an aggregate fund transfer issued to FSP partner bank 121 at the end of the day.

On day 1, in real-time, at step 702, FSP 120 may issue a request via API invocation to Bank A to receive $100 (in this example also, to illustrate that some specific amount of funds is chosen by the user, $100 is used as the chosen amount) from its FSP user (e.g., buyer 102). Bank A may receive the request and authenticate; for example, Bank A may confirm that the user identified owns the account identified and indicate whether it is ready to receive the money if authentication is successful. Again, because the API provides instant results, the money movement settlement is guaranteed, Bank A reliance on availability of funds is safe.

Upon receipt of the instructions via the API, at step 703, Bank A may credit the $100 from an internal cash account (e.g., a general ledger account) which is hosted inside the instant global funds transfer network of system 100 (e.g., hosted by FSP partner bank 121) to credit the $100 to the user's account with Bank A immediately (because money movement settlement is guaranteed) and then waits the standard 3 to 5 days for settlement. Because Bank A can credit the funds immediately to the user's account with Bank A, Bank A may release the funds immediately for completion of a transaction desired by the user of Bank A (e.g., buyer 102). For example, Bank A may release funds immediately to a seller 104, who then may process buyer's 102 order and proceed immediately to ship goods.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as processing component (e.g., processor, micro-controller, digital signal processor (DSP), etc.), system memory component (e.g., RAM), static storage component (e.g., ROM), disk drive component (e.g., magnetic or optical), network interface component (e.g., modem or Ethernet card), display component (e.g., CRT or LCD), input component (e.g., keyboard or keypad), and/or cursor control component (e.g., mouse or trackball). In one embodiment, disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, EPROM, FLASH-EPROM, any other memory chip or cartridge, carrier wave, or any other medium from which a computer is adapted.

In various embodiments, execution of instruction sequences for practicing the invention may be performed by a computer system. In various other embodiments, a plurality of computer systems coupled by communication link (e.g., LAN, WLAN, PTSN, or various other wired or wireless networks) may perform instruction sequences to practice the invention in coordination with one another.

Computer system may transmit and receive messages, data, information and instructions, including one or more programs (i.e., application code) through communication link and communication interface. Received program code may be executed by processor as received and/or stored in disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a first cash account managed by a computer at a partner bank of a financial service provider (FSP), wherein the first cash account is owned by the FSP;
a second cash account managed by a computer at the partner bank of the FSP, wherein the second cash account is owned by a financial institution where a user has an account; and
an application programming interface (API) for communication of financial transactions between the partner bank of the FSP and the financial institution where the user has an account, wherein
a financial service is provided instantly to the user via the API and use of internal funds transfers between the first cash account and the second cash account at the partner bank.

2. The system of claim 1, wherein the financial service is an instant top up of funds to an account of the user with the FSP.

3. The system of claim 1, wherein the financial service is an instant account verification, wherein at least one deposit of a random amount is made to the account of the user at the financial institution where the user has the account.

4. The system of claim 1, wherein the financial service is an instant direct debit from the account of the user at the financial institution where the user has the account.

5. The system of claim 1, wherein the financial service is an instant withdrawal of funds from an account of the user with the FSP to the account of the user at the financial institution where the user has the account.

6. The system of claim 1, wherein the API is a pre-defined API defined according to an ISO 20022 standard.

7. The system of claim 1, wherein the internal funds transfers are intrabank loop transfers.

8. A method comprising:
maintaining a first cash account, owned by a financial service provider (FSP), at a partner bank;
maintaining a second cash account, owned by a financial institution where a user has an account, at the partner bank;
invoking an application programming interface (API) for communication of financial transactions between the partner bank of the FSP and the financial institution where the user has an account; and
providing an instant financial service to the user via the API and use of internal funds transfers between the first cash account and the second cash account at the partner bank.

9. The method of claim 8, wherein providing the instant financial service comprises providing an instant top up of funds to an account of the user with the FSP.

10. The method of claim 8, wherein providing the instant financial service comprises providing an instant account verification, wherein at least one deposit of a random amount is made to the account of the user at the financial institution where the user has the account.

11. The method of claim 8, wherein providing the instant financial service comprises providing an instant direct debit from the account of the user at the financial institution where the user has the account.

12. The method of claim 8, wherein providing the instant financial service comprises providing an instant withdrawal of funds from an account of the user with the FSP to the account of the user at the financial institution where the user has the account.

13. The method of claim 8, wherein the invoking step comprises:
configuring a pre-defined API for the financial institution, wherein the pre-defined API is defined according to an ISO 20022 standard; and
invoking the configured, pre-defined API.

14. The method of claim 8, wherein the cash accounts are maintained according to due to-due from accounting.

15. A computer program product comprising a computer readable medium having computer readable and executable code for instructing a processor to perform a method, the method comprising:
maintaining a first cash account, owned by a financial service provider (FSP), at a partner bank;
maintaining a second cash account, owned by a financial institution where a user has an account, at the partner bank;
invoking an application programming interface (API) for communication of financial transactions between the partner bank of the FSP and the financial institution where the user has an account; and
providing an instant financial service to the user via the API and use of internal funds transfers between the first cash account and the second cash account at the partner bank.

16. The computer program product of claim 15 wherein the method further comprises providing an instant top up of funds to an account of the user with the FSP.

17. The computer program product of claim 15 wherein the method further comprises providing an instant account verification, wherein at least one deposit of a random amount is made to the account of the user at the financial institution where the user has the account.

18. The computer program product of claim 15 wherein the method further comprises providing an instant direct debit from the account of the user at the financial institution where the user has the account.

19. The computer program product of claim 15 wherein the method further comprises providing an instant withdrawal of funds from an account of the user with the FSP to the account of the user at the financial institution where the user has the account.

20. The computer program product of claim 15 wherein the method further comprises:
configuring a pre-defined API that is defined according to an ISO 20022 standard for the financial institution; and
invoking the configured, pre-defined API.
